(19) United States
(12) Patent Application Publication
(10) Pub. No.: US 2012/0028488 A1
(43) Pub. Date: Feb. 2, 2012

(54) Method And System For Transmitting Data To And From A Television

(75) Inventors: Greg Puschnigg, Ligonier, PA (US); Michael Krummey, Harrison City, PA (US)

(73) Assignee: GREEN POWER TECHNOLOGIES, LLC, King of Prussia, PA (US)

(21) Appl. No.: 13/269,531

(22) Filed: Oct. 7, 2011

Related U.S. Application Data
(63) Continuation-in-part of application No. 13/162,564, filed on Jun. 16, 2011.
Application No. 13/162,564 is a continuation of application No. 12/878,040, filed on Sep. 9, 2010, now Pat. No. 7,964,989.
(60) Provisional application No. 61/391,663, filed on Oct. 10, 2010.
(60) Provisional application No. 61/361,402, filed on Jul. 3, 2010.

(51) Int. Cl. H01R 29/00

(52) U.S. Cl. 439/189

(57) ABSTRACT

A system and method for remotely controlling power to for transmitting data to and from a television in a simple and efficient manner is disclosed herein. The system comprises an article, an electrically-powered device and a controller. The article comprises a cord, an alternating current outlet socket, an alternating current input plug, a latching relay, a processor, a transceiver and a content cable. The system preferably uses a WiFi communication signal to transmit data to and from the remote controller to the article.

### CROSS REFERENCES TO RELATED APPLICATIONS

The Present Application claims priority to U.S. Provisional Patent Application No. 61/391663, filed on Oct. 10, 2010, and the Present Application is a continuation-in-part Application of U.S. patent application Ser. No. 13/162564, filed on Jun. 16, 2011, which is a continuation application of U.S. patent application Ser. No. 12/878040, filed on Sep. 9, 2010, now U.S. Pat. No. 7,964,989, issued on Jun. 21, 2011, and claims priority to U.S. Provisional Patent Application No. 61/361402, filed on Jul. 3, 2010, now abandoned, all of which are hereby incorporated by reference in their entireties

### STATEMENT REGARDING FEDERALLY SPONSORED RESEARCH OR DEVELOPMENT

Not Applicable

### BACKGROUND OF THE INVENTION

1. Field of the Invention

The present invention generally relates to transmitting data to a television. More specifically, the present invention relates to a system and method for transmitting information to and from a television.

2. Description of the Related Art

Consumers are using their televisions for more than just watching television shows. Televisions are becoming the main portal for households to receive and transmit data. However, almost all televisions are not able to receive data other than through a cable provided by a cable company, a satellite dish provided by a satellite television company, or an antenna digital feed of local television stations. Televisions need to easily be able to receive data from other communication bands of the electromagnetic spectrum.

End Users are also becoming increasingly empowered to manage and save electrical power in their everyday lives. They understand that small changes in their behavior coupled with the use of smart power saving devices can minimize their power usage and save on their perpetually increasing energy bills. Additionally, End Users are continually searching for ways to have more control and customization over their environment for enhanced aesthetics and personal preferences and convenience.

The prior art discusses various method and systems for controlling power to an electrically power device.

One example is Dresti et al., U.S. Pat. No. 6,642,852 for a Remote Control Device With Appliance Power Awareness which discloses placing a device in a desired powered state through use of a infrared remote with radiofrequency capabilities.

Another is Lou et al, U.S. Patent Publication No. 2007/0115695 for a Power Supply With Low Standby Loss.

Yet another is Ewing et al., U.S. Pat. No. 7,171,461 for a Network Remote Power Management Outlet Strip.

Yet another is Lee et al., U.S. Publication No. 2010/0079001 for a Outlet Switch Socket Device.

The prior art fails to disclose a system and method for transmitting data to and from a television in a simple and efficient manner.

### BRIEF SUMMARY OF THE INVENTION

The present invention provides a system and method for transmitting data to and from a television in a novel and efficient manner. The present invention provides an effective component for transmitting data to and from a television.

One aspect of the present invention is an article for controlling electrical power to a television and for streaming wireless data to the television. The article comprises a cord, an alternating current socket, an alternating current input plug, a latching relay, a processor, a transceiver and a content cable. The alternating current outlet socket receives a plug from an electrically-powered device. The alternating current outlet socket is located at a first end of the cord. The alternating current input plug connects to an outlet to receive power. The alternating current outlet socket is located at a second end of the cord. The latching relay controls power to the alternating current outlet socket. The latching relay is electrically positioned within the cord between the alternating current input plug and the alternating current outlet socket. The processor is configured to instruct the latching relay to enable electrical power to the alternating current outlet socket and to disable electrical power to the alternating current outlet socket. The transceiver wirelessly receives data and a plurality of commands to the article utilizing a WIFI communication protocol, and wirelessly transmits data from the article utilizing a WIFI communication protocol. The transceiver is in electrical communication with the processor. The transceiver comprises an antenna extending along a portion of a length of the cord. The content cable is connected to the transceiver for receiving the data and delivering the data to a television which is connected to an end of the content cable.

The content cable is preferably a coaxial cable. The antenna of the transceiver preferably extends along the entire length of the cord. The length of the cord preferably ranges from four feet to ten feet, and the processor, latching relay and transceiver are preferably located in a center region of the cord. The content cable is alternatively an HDMI cable. The content cable is alternatively a composite cable comprising three connectors for audio and video transmissions. The content cable is alternatively an S-video cable. The content cable is alternatively a DVI cable. The content cable is alternatively a component video cable comprising three connectors for audio and video transmissions.

Another aspect of the present invention is a system for controlling electrical power to a television and for streaming wireless data to the television. The system comprises an article, a television and a controller. The article comprises a cord, an alternating current socket, an alternating current input plug, a latching relay, a processor, a transceiver and a content cable. The alternating current outlet socket receives a plug from an electrically-powered device. The alternating current outlet socket is located at a first end of the cord. The alternating current input plug connects to an outlet to receive power. The alternating current outlet socket is located at a second end of the cord. The latching relay controls power to the alternating current outlet socket. The latching relay is electrically positioned within the cord between the alternating current input plug and the alternating current outlet socket. The processor is configured to instruct the latching relay to enable electrical power to the alternating current outlet socket and to disable electrical power to the alternating current outlet socket. The transceiver wirelessly receives data and a plurality of commands to the article utilizing a WIFI communication protocol, and wirelessly transmits data from the article utilizing a WIFI communication protocol. The transceiver is in electrical communication with the processor. The transceiver comprises an antenna extending along a portion of a length of the cord. The content cable is connected to the transceiver for receiving the data and delivering the data to a television which is connected to an end of the content cable. The television is connected to the at least one power outlet connection of the article. The controller wirelessly transmits a plurality of commands to the article utilizing a WIFI communication protocol. A command of the plurality of commands from the controller can control electrical power to the television through the processor of the article which is configured to control electrical power to the television from the at least one power outlet connection and for delivering data to the television.

The system further comprises at least one wireless router that receives each of the plurality of commands from the controller and wirelessly transmits each of the plurality of commands to the transceiver of the article. The antenna of the transceiver preferably extends along the entire length of the cord. The length of the cord preferably ranges from four feet to ten feet, and the processor, latching relay and transceiver are preferably located in a center region of the cord. The content cable is alternatively an HDMI cable. The content cable is alternatively a composite cable comprising three connectors for audio and video transmissions. The content cable is alternatively an S-video cable. The content cable is alternatively a DVI cable. The content cable is alternatively a component video cable comprising three connectors for audio and video transmissions. The content cable is preferably a coaxial cable.

Another aspect of the present invention is an article for controlling electrical power to a television and for transmitting data to and from the television. The article comprises a cord, an alternating current socket, an alternating current input plug, a latching relay, a processor, a transceiver and a content cable. The alternating current outlet socket receives a plug from an electrically-powered device. The alternating current outlet socket is located at a first end of the cord. The alternating current input plug connects to an outlet to receive power. The alternating current outlet socket is located at a second end of the cord. The latching relay controls power to the alternating current outlet socket. The latching relay is electrically positioned within the cord between the alternating current input plug and the alternating current outlet socket. The processor is configured to instruct the latching relay to enable electrical power to the alternating current outlet socket and to disable electrical power to the alternating current outlet socket. The transceiver wirelessly receives data and a plurality of commands to the article utilizing a WIFI communication protocol, and wirelessly transmits data from the article utilizing a WIFI communication protocol. The transceiver is in electrical communication with the processor. The transceiver comprises an antenna extending along a portion of a length of the cord. The content cable is connected to the transceiver for receiving and transmitting the data to and from a television which is connected to an end of the content cable.

Yet another aspect of the present invention is a system for controlling electrical power to a television and for streaming wireless data to the television. The system comprises an article, a television and a controller. The article comprises a cord, an alternating current socket, an alternating current input plug, a latching relay, a processor, a transceiver and a content cable. The alternating current outlet socket receives a plug from an electrically-powered device. The alternating current outlet socket is located at a first end of the cord. The alternating current input plug connects to an outlet to receive power. The alternating current outlet socket is located at a second end of the cord. The latching relay controls power to the alternating current outlet socket. The latching relay is electrically positioned within the cord between the alternating current input plug and the alternating current outlet socket. The processor is configured to instruct the latching relay to enable electrical power to the alternating current outlet socket and to disable electrical power to the alternating current outlet socket. The transceiver wirelessly receives data and a plurality of commands to the article utilizing a WIFI communication protocol, and wirelessly transmits data from the article utilizing a WIFI communication protocol. The transceiver is in electrical communication with the processor. The transceiver comprises an antenna extending along a portion of a length of the cord. The content cable is connected to the transceiver for receiving and transmitting the data to and from a television which is connected to an end of the content cable. The television is connected to the at least one power outlet connection of the article. The controller wirelessly transmits a plurality of commands to the article utilizing a WIFI communication protocol. A command of the plurality of commands from the controller can control electrical power to the television through the processor of the article which is configured to control electrical power to the television from the at least one power outlet connection and for delivering data to the television. The controller also receives data from the television.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an elevational view of a preferred embodiment of an article for controlling power to and for transmitting data to and from an electrically powered device.

FIG. 2 is an elevational view of an alternative embodiment of an article for controlling power to and for transmitting data to and from an electrically powered device.

FIG. 3 is an elevational view of an alternative embodiment of an article for controlling power to and for transmitting data to and from an electrically powered device.

FIG. 4 is an elevational view of an alternative embodiment of an article for controlling power to and for transmitting data to and from an electrically powered device.

FIG. 5 is an elevational view of an alternative embodiment of an article for controlling power to and for transmitting data to and from an electrically powered device.

FIG. 6 is an elevational view of an alternative embodiment of an article for controlling power to and for transmitting data to and from an electrically powered device.

FIG. 7 is an elevational view of an alternative embodiment of an article for controlling power to and for transmitting data to and from an electrically powered device.

FIG. 8 is a block diagram of a system for controlling power and for transmitting data to and from an electrically powered device.

FIG. 8A is a block diagram of a system for controlling power and for transmitting data to and from an electrically powered device.

FIG. 9 is a front view of a controller in the form of a smartphone with a status report on a screen of the controller.

FIG. 10 is a cross-sectional view of the article.

FIG. 11 is a block diagram of the circuitry of the article.

### DETAILED DESCRIPTION OF THE INVENTION

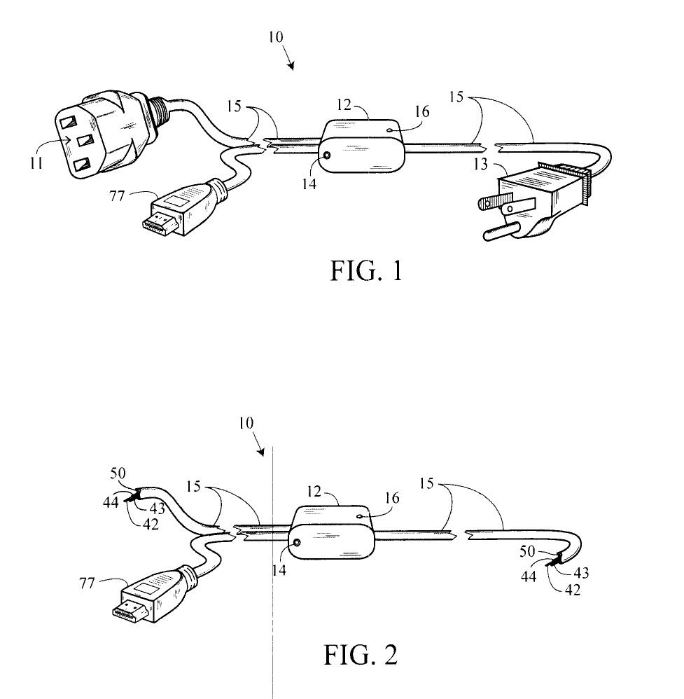

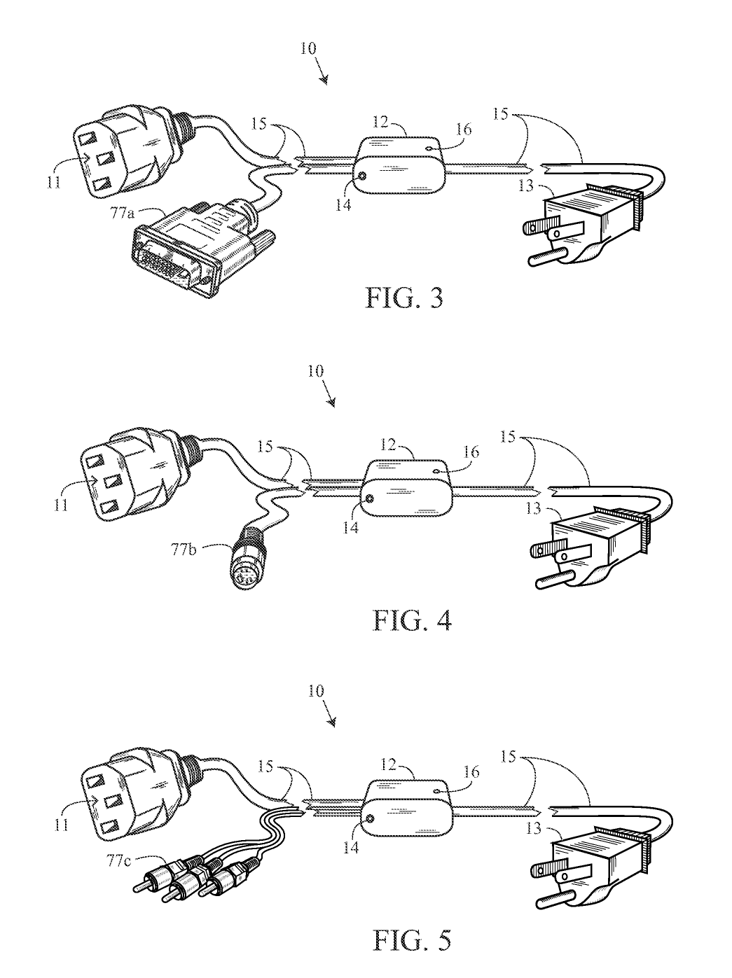

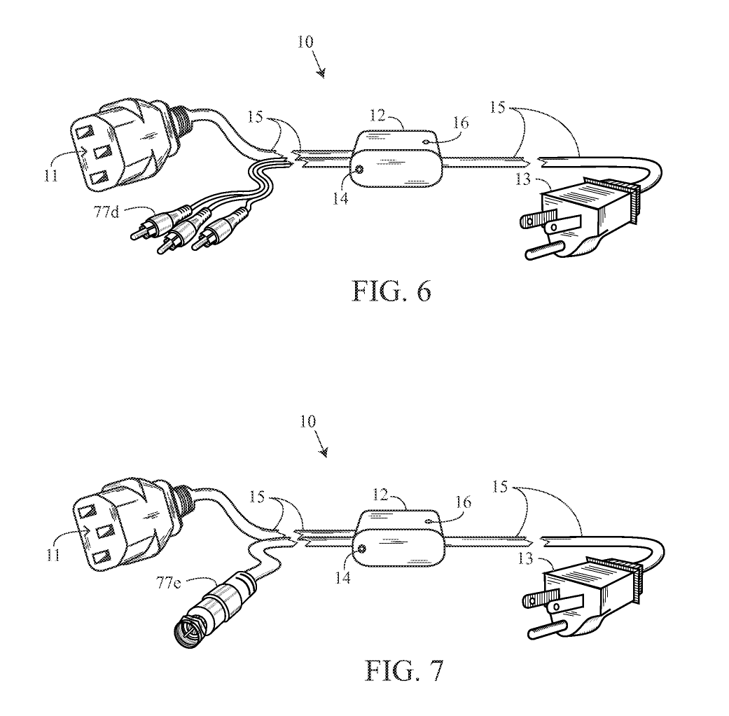

A preferred embodiment of an article 10 utilized for controlling power and for transmitting data to and from an electrically powered device is shown in FIGS. 1-7, in the form of an extension cord. The article 10 comprises of at least one controlled socket 11, a casing 12, a plug 13, a switch 14, a cord 15 and a content cable 77. The content cable 77 is preferably an HDMI cable as shown in FIGS. 1 and 2. The content cable is alternatively a DVI cable 77a as shown in FIG. 3. The content cable is alternatively an S-video cable 77b as shown in FIG. 4. The content cable is alternatively a component video cable 77c comprising three connectors for audio and video transmissions as shown in FIG. 5. The content cable is alternatively a composite cable 77d comprising three connectors for audio and video transmissions as shown in FIG. 6. The content cable is alternatively a coaxial cable as shown in FIG. 7.

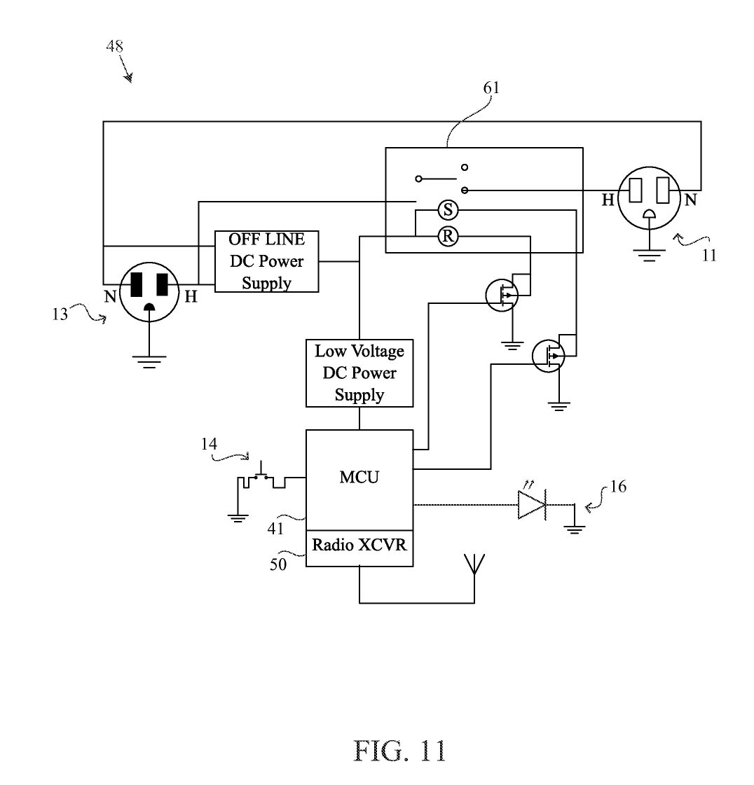

In FIG. 10, the interior components of the article 10 are shown and in FIG. 11 a circuit block diagram for the article 10 is shown. The article 10 further comprises at least a radio transceiver 50, a microprocessor 41, a switch 61, and a power converter. Additionally, light-emitting diodes (LED) 45 provide status indication.

The plug 13 is used to receive alternating current (AC) power, and the switch 61 is connected in between the socket 11 and the plug 13.

The microprocessor 41 receives direct current (DC) power, decodes a control signal from a remote control, such as a handheld device, via the radio transceiver 50, and then controls the switch 61 based on the decoded control signal.

The switch 61 is preferably a latching relay controlled by the microprocessor 41, according to the control signal received from the remote control device. The latching relay minimizes the power usage of the electrical device connected to the apparatus 10, independent of the state of the switch 61.

Further embodiments of the present invention include additional onboard energy storage, with sensing or measuring capabilities, in various form factors embedded or interfaced with various electrical components such as, but not limited to; cords, outlets, converters, circuit breakers and surge protectors. Additional embodiments of the present invention include combining a single or multiple energy harvesting sources to provide power to control the relay.

In the preferred embodiment, the radio transceiver preferably includes an antenna 50 positioned within the cord 15 in order to increase the reception power of transceiver. In addition to the antenna, the cord 15 also comprises of three wires 42-44 (hot, neutral and ground). The antenna runs parallel in the power cord for increased performance.

FIG. 10 shows the internal components of the cord 15. There are conductors for the three wires 42-44 for the socket and a fourth encased conductor 55 for the antenna 50, all preferably molded within insulating material 51. The antenna 50 preferably comprises of a protective sleeve 52, a shielding copper braid 53, foam 54, and a copper conductor 55; or other such materials typically used to protect the antenna 50 from interference of the other wires 42-44. Further, the antenna 50 is preferably positioned as far as possible from the three other wires 42-44 to minimize the interference from the wires 42-44.

The article 10 of this embodiment preferably has two controlled sockets 11 located on the front of the module. The casing 12 is preferably injection molded insulating material. Both sockets 11 are controlled with the same ON/OFF command. The article 10 is comparable in function and usability to standard extension cords and plugs. The mechanical interactions for the user using the article 10 does not compromise safety or functionality compared to standard extension cords and plugs. The article 10 plugs securely into a single outlet of a standard duplex wall receptacle and the plug 13 is configured in such a way that the other outlet is not impeded. Each socket 11 of the article 10 preferably has a current rating of 15 amperes (A) at 120 volts in alternating current (V AC). The content cable 77 preferably connects to a television for transmitting data to and from the television including content such as television shows. Alternatively, the content cable connects to an appliance and can be used bi-directional communications for diagnostic reporting, software upgrades, troubleshooting and the like.

A pushbutton switch 14 on the apparatus 10, when activated, preferably resets the article 10 to the factory default conditions for the configuration settings.

The article 10 preferably has a LED indicator 16 that is ON when the apparatus 10 obtains and maintains a wireless connection to the LAN (local area network) and OFF when the article 10 does not have a wireless connection to the LAN.

The LED indicator 16 also preferably represents the state of the outlet power for the article 10 as well, which is preferably accomplished by blinking in a set pattern. Alternatively, the LED indicator 16 flashes accordingly to indicate the status of the wireless connection.

In the event of a power failure, the article 10 automatically returns managed sockets 11 to the previous state, prior to power interruption. In the event of a dropped wireless connection, the article 10 maintains port settings last set by the user, prior to the loss of wireless connectivity, until the wireless connectivity is restored or until the user disconnects the article 10.

The article 10 permits the user to configure the article 10 out of the box using a web user interface (WebUI), a personal computer (“PC”) program or a WiFi enabled hand held device (smartphone) via ad-hoc wireless, allowing the user to program in home network information, such as the wireless router SSID (Service Set Identifier) and security keys, as necessary for web connectivity.

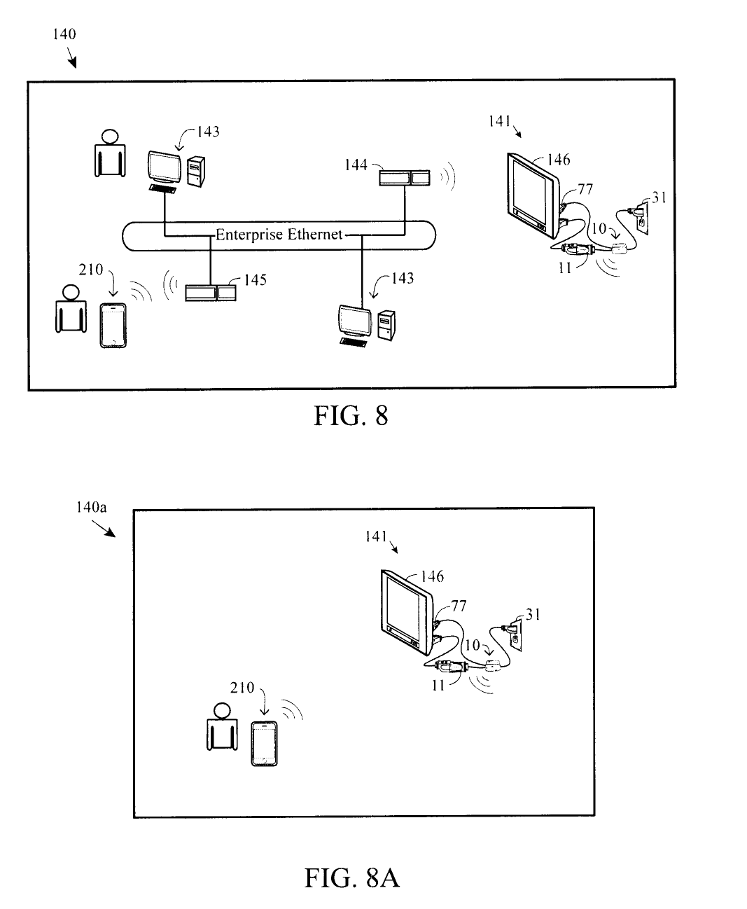

A networked system 140 of the preferred embodiment is shown in FIG. 8. Such a system and other articles are also described in Puschnigg et al., U.S. patent application Ser. No. 12/878040, filed on Sep. 9, 2010, for a Method And System For Controlling Power To An Electrically Powered Device, which is hereby incorporated by reference in its entirety.

The WebUI is preferably hosted on the article 10 and is accessible via interconnected network devices. The WebUI, PC program or WiFi enabled hand held is addressable via the assigned IP address of the article 10. The article 10 can be controlled from various devices such as, but not limited to, computers 143 or mobile handhelds 210. In a typical network, the router 144 and the access point 145 provide the wireless connectivity between the article 10 and the remote, such as a smart phone 210. An alternative embodiment of the system 140 is illustrated in FIG. 8A. In this embodiment, the mobile handheld device 210 wireless communicates directly with the antenna 50 of the article 10 preferably using a WiFI communication protocol.

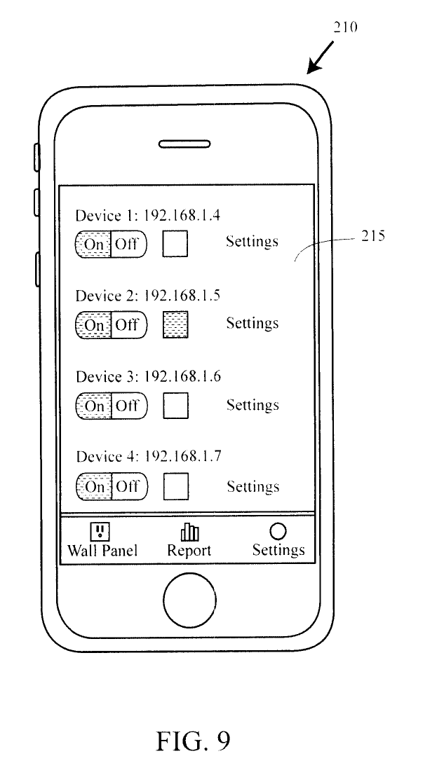

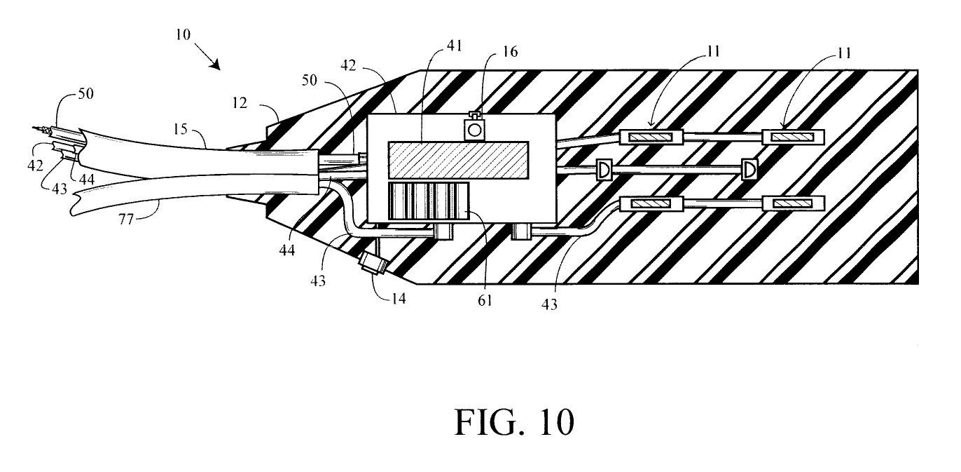

FIG. 9 shows a smart phone 210 displaying touch screen commands 215 of an application for controlling power to electrically powered devices plugged into the article 10.

In FIG. 8, a system 141 shows a television 146 plugged into the first installed apparatus 10, which is plugged into a wall outlet 31. The system can network and the first installed article 10 is the master article 10 and monitors the network for any additional articles. When a new article is detected on the network, the first article 10 remotely manages other articles using a single WebUI, PC program or WiFi enabled hand held. The user will either: a) logon to the original article 10 and have selectable tabs and additional options to manage all of the articles on the network; or b) manage each article discretely using individual IP addresses. Local user settings to the individual apparatus 10b supersede commands and/or timers from the master article 10. The article 10 is compatible with various web browsers such as, but not limited to, Mozilla Firefox, Microsoft Explorer and Google Chrome.

A simple WebUI home page allows individual management and supervision of each socket 11 such as, but not limited to, setting multiple timers and toggling ON/OFF selections of individual sockets 11. The status page displays the status of the devices and users can turn devices OFF or ON from this page.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

We claim as our invention:

1. An article for controlling electrical power to a television and for streaming wireless data to the television, the article comprising:
a cord;
an alternating current outlet socket for receiving a plug from an electrically-powered device, the alternating current outlet socket located at a first end of the cord;
an alternating current input plug for connection to an outlet to receive power, the alternating current outlet socket located at a second end of the cord;
a latching relay for controlling power to the alternating current outlet socket, the latching relay electrically positioned within the cord between the alternating current input plug and the alternating current outlet socket;
a processor configured to instruct the latching relay to enable electrical power to the alternating current outlet socket and to disable electrical power to the alternating current outlet socket;
a transceiver for wirelessly receiving data and a plurality of commands to the apparatus utilizing a WIFI communication protocol, and for wirelessly transmitting data from the apparatus utilizing a WIFI communication protocol, the transceiver in electrically communication with the processor, the transceiver comprising an antenna extending along a substantial portion of a length of the cord; and
a content cable connected to the transceiver for receiving the data and delivering the data to a television connected to an end of the content cable.

2. The article according to claim 1 wherein the content cable is a coaxial cable.

3. The article according to claim 1 wherein the antenna of the transceiver extends along the entire length of the cord.

4. The article according to claim 1 wherein the length of the cord ranges from four feet to ten feet, and the processor, latching relay and transceiver are located in a center region of the cord.

5. The article according to claim 1 wherein the content cable is an HDMI cable.

6. The article according to claim 1 wherein the content cable is a composite cable comprising three connectors for audio and video transmissions.

7. The article according to claim 1 wherein the content cable is an S-video cable.

8. The article according to claim 1 wherein the content cable is a DVI cable.

9. The article according to claim 1 wherein the content cable is a component video cable comprising three connectors for audio and video transmissions.

10. A system for controlling electrical power to a television and for streaming wireless data to the television, the system comprising:
an article comprising
a cord,
an alternating current outlet socket for receiving a plug from an electrically-powered device, the alternating current outlet socket located at a first end of the cord
an alternating current input plug for connection to an outlet to receive power, the alternating current outlet socket located at a second end of the cord,
a latching relay for controlling power to the alternating current outlet socket, the latching relay electrically positioned within the cord between the alternating current input plug and the alternating current outlet socket,
a processor configured to instruct the latching relay to enable electrical power to the alternating current outlet socket and to disable electrical power to the alternating current outlet socket,
a transceiver for wirelessly receiving data and a plurality of commands to the apparatus utilizing a WIFI communication protocol, and for wirelessly transmitting data from the apparatus utilizing a WIFI communication protocol, the transceiver in electrically communication with the processor, the transceiver comprising an antenna extending along a substantial portion of a length of the cord
a content cable connected to the transceiver for receiving the data and delivering the data to a television connected to an end of the content cable;
a television connected to the at least one power outlet connection of the article; and
a controller for wirelessly transmitting a plurality of commands to the article utilizing a WIFI communication protocol;
wherein a command of the plurality of commands from the controller can control electrical power to the television through the processor of the article which is configured to control electrical power to the television from the at least one power outlet connection and for delivering data to the television.

11. The system according to claim 10 further comprising at least one wireless router for receiving each of the plurality of commands from the controller and wirelessly transmitting each of the plurality of commands to the transceiver of the article.

12. The system according to claim 10 wherein the antenna of the transceiver extends along the entire length of the cord.

13. The system according to claim 10 wherein the length of the cord ranges from four feet to ten feet, and the processor, latching relay and transceiver are located in a center region of the cord.

14. The system according to claim 10 wherein the content cable is an HDMI cable.

15. The system according to claim 10 wherein the content cable is a composite cable comprising three connectors for audio and video transmissions.

16. The system according to claim 10 wherein the content cable is an S-video cable.

17. The system according to claim 10 wherein the content cable is a DVI cable.

18. The system according to claim 10 wherein the content cable is a component video cable comprising three connectors for audio and video transmissions.

19. A system for transmitting data to and from a television, the system comprising:
an article comprising
a cord,
an alternating current outlet socket for receiving a plug from an electrically-powered device, the alternating current outlet socket located at a first end of the cord
an alternating current input plug for connection to an outlet to receive power, the alternating current outlet socket located at a second end of the cord,
a latching relay for controlling power to the alternating current outlet socket, the latching relay electrically positioned within the cord between the alternating current input plug and the alternating current outlet socket,
a processor configured to instruct the latching relay to enable electrical power to the alternating current outlet socket and to disable electrical power to the alternating current outlet socket,
a transceiver for wirelessly receiving data and a plurality of commands to the apparatus utilizing a WIFI communication protocol, and for wirelessly transmitting data from the apparatus utilizing a WIFI communication protocol, the transceiver in electrically communication with the processor, the transceiver comprising an antenna extending along a substantial portion of a length of the cord
a content cable connected to the transceiver for transmitting data to and from a television connected to an end of the content cable;
a television connected to the at least one power outlet connection of the article; and
a controller for wirelessly transmitting to and from the article utilizing a WIFI communication protocol.

20. The system according to claim 19 wherein the content cable is a component video cable comprising three connectors for audio and video transmissions.
